(19) United States
(12) Patent Application Publication
(10) Pub. No.: US 2023/0165178 A1
(43) Pub. Date: Jun. 1, 2023

(54) PLOUGH MODULE AND PLOUGH DEVICE COMPRISING AT LEAST ONE PLOUGH MODULE

(71) Applicant: Huber Soil Solution GmbH, Wagna (AT)

(72) Inventor: Franz-Ferdinand Huber, Wagna (AT)

(21) Appl. No.: 17/921,646

(22) PCT Filed: Apr. 27, 2021
(86) PCT No.: PCT/EP2021/060937

§ 371 Date: Oct. 27, 2022

(30) Foreign Application Priority Data
Apr. 29, 2020 (DE) 10 2020 205 428.2

(51) Int. Cl. A01B 5/10; A01B 9/00; A01B 13/08

(52) U.S. Cl. CPC A01B 5/10; A01B 9/003; A01B 13/08

(57) ABSTRACT

The invention relates to a plough module (1) with plough-following stabilisation for mounting on a base frame of a plough device, comprising a rotatable first cutting element designed as a hollow-disc cutting plate. A lateral region (122) of a soil ridge can be cut away by moving the plough module (1) on the ground along a ploughing direction (110). The plough module (1) comprises a second plat cutting element (105) with a second cutting edge (106), wherein a base region (121) of the soil ridge can be cut away by moving the plough module (1) on the ground. The plough module (1) is designed as a fully assembled unit, in which the second cutting element, designed as a fixed cutting blade (6), follows the first cutting element (102) in the ploughing direction (110). The cutting blade (6) is angled backwards relative to the working angle, achieving a dynamic balance of forces between the first cutting element (102) and the cutting blade (6) for plough-following stabilisation. A contact plate (8) is provided on the cutting blade (6), which is supported on a furrow wall (121) such that a stabilising effect follows the plough.

The present invention relates to a plow module having plow-following stabilization for replaceable mounting on a base frame of a plow device for plowing ground as claimed in the preamble of claim 1, and as claimed in claim 14 a plow device which is provided with at least one such plow module.

When plowing with such a plow device which is generally pulled by a tractor, so-called soil ridges are cut out of the soil. A soil ridge has a lateral region along which a first cutting element cuts or has cut. Moreover, the soil ridge has a base region which connects the two lateral regions and is cut from the ground by means of a second cutting element. Correspondingly, the ground has a cut surface (so-called furrow bed) on the base region of the soil ridge. An approximately rectangular soil ridge is cut-out from the ground, wherein a horizontal cutting plane (=furrow bed) is produced by means of the second cutting element and a vertical cutting plane (=furrow wall) is produced by means of the first cutting element on the remaining ground. By cutting out the soil ridge, a furrow wall is formed in the ground from which the lateral region of the soil ridge has been detached. The base region thus defines the vertically lowermost surface of the soil ridge when cut from the ground.

It should be mentioned that the terms horizontal and vertical and top and bottom refer to arrangements and configurations of the plow devices and thus the plow module according to the invention fastened thereto, wherein the plow device is observed positioned on the ground as intended and is movable in the direction of cultivation during the operation of the plow.

A relevant plow device is disclosed in DE 10 2017 102 683 A1. A rotatable first cutting element, which is configured as a cutting plate with a circumferential first cutting edge, is arranged on the base frame of this plow device, wherein the first cutting element is configured such that a lateral region of a soil ridge of the ground can be cut away by moving the plow device on the ground in a plowing direction. The plowing direction or direction of cultivation is defined as the direction in which the plow device is moved over the ground. A second planar cutting element with a second cutting edge is also fastened to the base frame and is arranged in the plowing direction upstream of the first cutting element. The second cutting element is configured such that the base region of the soil ridge can be cut away by moving the plow module on the ground in a plouging direction. When plowing with this plow device, the base region of the soil ridge to be formed is initially cut by means of the second cutting element. The following first cutting element, which is configured as a cambered cutting plate, then cuts a lateral region of the soil ridge and places this soil ridge turned over in the furrow which has been formed. Such a plow device requires significantly less tractive force relative to conventional plows with plow bodies and moldboards.

It is a drawback in the case of a plow device according to DE 10 2017 102 683 A1 that the different cutting elements are mounted individually on the base frame, which impedes the mounting or retrofitting on a conventional base frame for plows. Additionally, the spatial orientation of the two cutting elements to one another is complicated and the setting or adjustment thereof often is only possible to a small extent.

A device for cultivating hop crops is disclosed in DE 203 04 036 Ul. The device is provided to be articulated to a tractor and has a base frame, at least two working implements being fastened thereto. A first working implement is a bine removal device for removing a bine in order to expose the vine stems of the hop rootstock in the bine, whereas a second working implement is provided in the form of a cutting device for cutting off the exposed vine stems of the hop rootstock. An extension arm is provided on the base frame, the respective working implements being fastened thereto via respective control rods. Both working implements are arranged one behind the other and permit the bine to be treated in order to expose the vine stems and subsequently to cut away the vine stems in one working process. Plowing is not possible with this known device for cultivating hop crops.

The plow module according to the unpublished DE 10 2019 204 256 2 of the same applicant operates according to the principle that a cutting element undercuts the soil ridge, which is to be cut out of the furrow wall and turned, and then turns the soil ridge with the hollow disk which functions quite well as a whole. However, in this known plow it has been shown that there is no balancing of forces following the plow module. This means that, in practical use, the plow which usually has a plurality of plow modules can also break out to the side during plowing due to the non-homogeneity of the soil flow. The ground compaction and ground composition are frequently highly variable, whereby the cutting width and the cutting depth of the leading first hollow disk change significantly. This leads to the transverse forces being greater in one direction than in the opposing direction, whereby the plow loses its guidance. This means that the plow exhibits the tendency to be positioned transversely and to break out of the furrow which acts as a neutral pull line. These forces acting on the plow and the plow modules lead to a high level of stress on the bearings of the hollow disk.

The use of a moldboard plow, which is also known, leads to an improved control of the plow-following, since the actual plow body is braced with a relatively large plow support against the furrow wall, whereby the plow-following, i.e. the running of the plow on the neutral pull line, is stabilized. However, this has to be obtained at the expense of a substantially greater expenditure of tractive force when pulling the plow through the ground.

The object of the present invention is thus to modify a plow of the known design of modular construction, such that the transverse forces are balanced and the plow can be kept in a straight line, i.e. in a straight following line, so that the plow-following line as a whole can be stabilized.

This object is achieved by a plow module having the features as claimed in claim 1 and by a plow device having the features as claimed in claim 14. Expedient developments are defined in the dependent claims.

This object is achieved for a plow module as a pre-mounted structural unit and for a plow device having such a plow module, by the second cutting element being configured as a fixed cutting blade and being angled back to the rear, i.e. counter to the plowing direction, such that a dynamic balance of forces is able to be achieved between the first cutting element and the cutting blade in the sense of a stabilization of the plowing direction. The plow module generally has a first carrier structure on which the first cutting element is arranged and a second carrier structure on which the second cutting element is arranged. The second carrier structure is connected to the first carrier structure, wherein the first carrier structure has means for releasable fastening to a base frame of a plow device which has at least one plow module. In the plow module, the second cutting element is arranged downstream of the first cutting element in the plowing direction, and in addition to at least one, preferably two, plow modules of the plow device according to the invention additionally has a contact plate which is supported on the furrow wall and thus supports the plow device as a whole and the respective plow module, stabilizing its following line.

According to a first aspect of the present invention, the plow module is described for a plow device for plowing ground. The plow module has a first carrier structure, a rotatable cutting element, for example a cambered disk, being arranged thereon. A second cutting element, for example a cutting blade which is arranged at a defined angle, is mounted on a second carrier structure which in turn is fixedly connected to the first carrier structure. The rotatable first cutting element has a circumferential first cutting edge and is configured such that when the plow device is moved with the carrier structure on the ground in the plowing direction thereof, i.e. the direction of cultivation, a lateral region of a soil ridge of the ground is cut away, in particular from a furrow wall, by means of a first cutting region of the first cutting edge. The first and the second carrier structure are fixedly connected together and are arranged together on the basic structure of the plow device. The second cutting element has a second cutting edge, wherein the second cutting element is arranged on the second carrier structure and is configured such that, when the plow module is moved on the ground in the plowing direction, a base region of the soil ridge of the ground can be cut away by means of a second cutting region of the second cutting edge, in particular along a cut surface between the soil ridge and the plow bed. The second cutting element is arranged relative to the first cutting element in the plouging direction, such that the second cutting region is located downstream of the first cutting region in the plowing direction.

Preferably, the respective cutting elements on the plow module are adjustable, preferably pivotable, relative to their position to one another. This represents a clear advantage. Thus, for example, it is possible to use a plow module in which the first cutting element for cutting the side of the soil ridge can be arranged upstream of the second cutting element for cutting the base of the soil ridge.

Preferably, a plow device has a plurality of plow modules, for example three to six plow modules, on a plow side, i.e. relative to a base frame a total of six to 16 modules. Relative to the known plow devices in which the first cutting element for cutting the side of a soil ridge is arranged downstream of the second cutting element which cuts the base of a soil ridge or a furrow from which the soil ridge is cut, this known arrangement has obviously been selected since the first cutting element in cooperation with a guide plate, or in an embodiment as a hollow disk, for example, is responsible for turning the cut-out soil ridge. To this end, the bed of a furrow, i.e. the lower side of a soil ridge, has to be already cut. Thus in the known devices, regarding its active cutting edge, the second cutting element is arranged upstream of the first cutting element. By this arrangement, after cutting the side wall of the soil ridge the first cutting element can turn this soil ridge immediately, since the furrow bed is already cut. So that the first cutting element can reliably cut the side, or in a curved configuration also prepare the soil ridge for turning and initiate the turning, naturally the drive or the bearing or the holder of the first cutting element has to be provided on the rear face thereof. This in turn means, however, that the second cutting element and the first cutting element have to have in each case a separate carrier by which they are attached to the frame. Thus an adjustment of the two cutting elements relative to one another is significantly impeded.

Accordingly, in the present invention, the first cutting element which cuts the side of the soil ridge is arranged upstream of the second cutting element which cuts the bottom surface of the soil ridge or the furrow. Normally this is not taken into consideration, since in a plow device in which the first cutting element for cutting the side of the soil ridge is arranged first in the pulling direction, it cannot still perform the turning function, although the shape is configured as a hollow disk and is provided in principle for turning the soil ridge. This is because the furrow base has not yet been cut. The advantage of the module according to the invention is that only two cutting elements have to be provided, without a guide plate or moldboard being required. The advantage according to the invention is also that due to the fact that the first cutting element has the drive or the bearing or the carrier structure on its rear face, and in an arrangement upstream of the second cutting element, which also has a carrier structure, the two carrier structures of the first cutting element and the second cutting element can be connected together, resulting in a module which can be attached with a single suspension device to the carrier frame of the plow device. The deciding advantage is that a conventional plow device having plow bodies can be converted, and namely without great effort, by the plow bodies being dismantled and a corresponding module being mounted. Naturally, the conventional base frames, also called plow trees, can be equally provided in the factory with the plow modules according to the invention.

It has surprisingly been shown, therefore, that in a plow device with a leading cutting element as a hollow disk, it is possible to cut the lateral region without first being followed by turning since the furrow base is not yet cut. This is only completed by the following second cutting element. If a plurality of such modules are arranged one behind the other in a plow device, it has been shown that when the second module follows the first module, when viewed in the plowing direction, the first cutting element not only cuts the side surface of the soil ridge present but the furrow base is already cut there by the first module. Thus the desired function can be directly carried out by the second module, namely that the first cutting element in the form of a hollow disk cuts the side surface of the soil ridge and at the same time can turn the soil ridge.

Regarding the construction, it is possible to make use of the fact that the holder or carrier structure of the first cutting element faces to the rear toward the carrier structure for the second cutting element, so that a simple attachment and connection of the two cutting elements is possible here to form a module. If the plow device, for example, has only one plow module, then with the very first pass when plowing a field this very first pass would be a pass in which cutting takes place of the side of the soil ridge which has not yet been cut free, so that only a partial turning takes place. However, with the second pass, a complete turning of the soil ridge, which is cut away at the side, would immediately take place by means of the first cutting element, since the second cutting element would have already cut away the furrow bed in that region and thus the underside of the soil ridge. This results in considerable advantages relative to the conventional plow devices. A replacement or conversion of conventional plow devices with plow bodies to the plow modules according to the invention is possible in a simple manner. It is also possible in a simple manner, due to the modularity, to replace in a rapid manner defective plow modules or other plow modules on the plow device which have been correspondingly adapted due to a changed ground structure.

Since in practical use, by the non-homogeneity of the soil flow, i.e. due to the variable ground compaction and ground composition, the plow can break out to the side, it does not follow the ideal following line. As a result, the cutting width and cutting depth can significantly change, in particular of the first hollow disk, whereby the transverse forces are no longer balanced but act differently on both sides. As a result, the plow loses guidance and deviates in the direction of the respectively greater transverse force. The plow is thus positioned to a certain extent transversely and breaks out of the straight pulled furrow, namely the neutral pull line. This leads to a greater stress on the bearings of the hollow disk. According to the invention, the fixed cutting blade forming the second cutting element is angled back to the rear, whereby a dynamic balance of forces can be achieved between the first cutting element and the cutting blade in the sense of plowing direction stabilization. “Fixed” is understood to mean, in the context of the cutting blade, the difference from a rotating disk for cutting the furrow bed which is also known in the prior art. The angle as to how far the cutting blade is inclined to the rear is adjustable and in this respect, but only in this respect, is fixed after it is adjusted to a specific angle corresponding to the ground.

A contact plate cooperating with the cutting blade is provided, said contact plate extending so to speak on the cutting blade transversely to the longitudinal direction thereof. This contact plate is additionally provided and supported on the furrow wall. Thus it cooperates with the cutting blade in a supporting and stabilizing manner in the plowing direction, whereby it forms a cutting blade-contact plate-guide unit. The blade thus cuts the furrow base after the furrow wall, i.e. the lateral region of the soil ridge, has been cut away. The contact plate is supported on the side wall, i.e. the furrow wall, whereby a lateral guidance is provided. The cutting blade-contact plate-guide unit, denoted as the contact plate-undercutting blade-unit, acts as a grinding shoe, so to speak, with a support function. This combination of the cutting blade and the contact plate located thereon provides the plow device with a plow-following stabilization, whereby the plow is prevented from breaking out to the side. To this end, it is required for the plow device that at least one such contact plate-undercutting blade-unit is preferably provided on the first plow module in the plowing direction. Preferably, such a unit is also provided on the last plow module. The provision of such a unit at the start and at the end of a plow device having a plurality of plow modules is particularly advantageous in this case for the plow-following stabilization. However, it is not absolutely necessary that the described unit has to be attached to each plow module. Naturally, it is conceivable and possible in the sense of uniformity and standardization to design all modules the same. This has substantial advantages if the plow modules have to be replaced, since then different stocks are not required for storing plow modules to be repaired or to be replaced. Moreover, the required tractive force can be further reduced if such a unit is attached to each plow module.

According to the respective ground conditions the contact plate attached to the cutting blade can be configured to be adjustable relative to its height, its angle relative to the plow-following line and relative to the inclination angle of the cutting blade surface. The adjustability can be carried out electrically, mechanically or hydraulically.

The plow module according to the invention is particularly advantageous if, in addition to the adjustability of the contact plate, both the first and the second cutting element can be adjusted regarding their positions relative to one another. This results in an adjustability relative to the ground to be plowed, and an adjustability of the two cutting elements individually or together. The second cutting element in this case is pivotable on the carrier structure, on which the first cutting element is fastened, in order to orientate the inclination of the second cutting element slightly downwardly when cutting through the ground, so as to prevent this cutting element which cuts the furrow base from moving out during plowing and at the same time to keep the first cutting element in the ground. The first cutting element is pivotable and displaceable in a plurality of directions and thus has several degrees of freedom in order to produce a correspondingly optimal plowing result in cooperation with the two cutting elements relative to one another.

The provision of a plurality of modules on a plow device also has the advantage that a greater width can be plowed in one pass with the device according to the invention. It is also expedient to pivot the cutting elements out of engagement when plowing the edge of a field to be plowed and when the width for the last pass might otherwise be too great, such that the risk might be present that the ground is cut with the plow module arranged furthest to the side, for example a piece of ground which possibly might already be in the neighboring field. In order to avoid this, by pivoting the cutting element(s) out of engagement such a situation can be avoided.

The plow module according to the invention is coupled via the basic structure of the plow device to a traction machine, such as for example a tractor, which thus pulls the cutting elements in the plowing direction through the ground. The basic structure can also be part of a support iron or a beam. By means of the plow modules, which consist of two cutting elements arranged on combined carrier structures, namely a first cutting element for cutting the side of a soil ridge and for turning, and a second cutting element for cutting the furrow bed, beams can also be entirely dispensed with. The carrier structure has metal bars and/or fiber composite elements. Moreover, as described in detail below, the attached elements can be adjustably fastened to the carrier structure.

The plow tree or the carrier frame, which is formed from the first and the second carrier structure, thus provides a fastening structure which is rigid but suitable for adjustment for the cutting elements on the plow modules and the contact plate on the second cutting element and for additional components such as joints or adjusting elements. In other words, the cutting elements are fixed to the respective first or second carrier structure, such that relative movement is not possible between the cutting elements during plowing. If during plowing the second cutting element is pushed into the ground due to the cutting of the soil ridge, at the same time the first cutting element is pushed into the ground by means of a pull-in force. Preferably, the cutting elements and the contact plate, however, are adjustable even during plowing, which for example can be carried out electrically or hydraulically.

According to an exemplary embodiment, the first and/or the second cutting element are or is pivotably fastened, for example by means of a joint on the respective carrier structure, so that the angle between the rotational axis and the direction of extension of the second cutting edge is adjusted and can be fixed in a desired position. In a further advantageous embodiment of the invention, the second carrier structure itself is pivotably connected via a joint to the first carrier structure. As a result, the angle of attack of the second cutting element is adjustable relative to the plouging direction. The angle of attack in this case generally is such that the leading cutting edge is oriented slightly downwardly into the soil.

The second cutting element, which is configured as a cutting blade, and the contact plate are angularly pivotable via a common pivot axis together with the angle of attack of the cutting blade. Thus the soil ridge can be undercut such that the plow remains at the desired depth and the contact plate can be adapted to different ground conditions in an adjustable manner for a supporting action on the furrow wall, in combination with plow-following stabilization. Additionally, a perforated plate is provided, the height of the contact plate together with the cutting blade on the respective module of the plow device also being able to be adjusted therein.

In a further exemplary embodiment, the first cutting element and/or the second cutting element are arranged in a pivotable and/or translationally displaceable manner on the respective carrier structure, in order to adjust the angle of attack and the relative positions to one another. Thus a position and/or an angle of the cutting elements to one another can also be adjusted according to the ground conditions and according to the desired cultivation depth, in addition to the angle of attack of the second cutting element relative to the plowing direction.

A device, such as for example the above-described joint, serves for displacing the cutting element angle (angle of attack of cutting blade) and permits the adjustment of the cutting element inclination angle (vertical inclination of hollow disk relative to the furrow wall of the ground) and the cutting element-direction angle (to the plowing direction, i.e. to the direction of travel of the tractor). The cutting line of the cutting element between the first cutting edge and the furrow wall can be adjusted in terms of height by means of an adjustable support. Accordingly, the vertical and/or horizontal spacing between the first cutting element and the second cutting element can be variably adjusted. In other words, in a further exemplary embodiment, the first cutting element and the second cutting element can be arranged relative to one another such that the cutting region of the first cutting edge of the first cutting element is vertically spaced apart from the second cutting edge of the second cutting element. The cutting width or plow width of a pass is able to be adjusted by means of an adjustment in the horizontal direction.

In one embodiment of the invention, it is preferred that the first cutting region is configured in a first cutting plane and the second cutting region is configured in a second cutting plane, wherein the first cutting plane and the second cutting plane form relative to one another an angle of 30° to 135°, in particular 45° to 110°. The desired angle can be adjusted by the two cutting elements being pivotably mounted on the respectively associated carrier structure. Naturally, a predetermined fixed orientation of the two cutting planes also lies within the scope of the invention.

The first cutting edge in this case runs in a first cutting plane whilst the second cutting edge runs in a second cutting plane. The first cutting element and the second cutting element in this case are fastened relative to one another on the carrier structure such that the first cutting plane and the second cutting plane are at an angle to one another of, in particular, more or less than 90° (opening angle). In other words, in a further exemplary embodiment, the first cutting element can be arranged such that an angle of approximately 0° to ±30° is present between the rotational axis of the first cutting element and a direction of extension of the second cutting edge. In particular, the normal of the first cutting plane has a (directional) component which is parallel to a horizontal direction when the plow device is positioned on the ground as intended. The rotational axis of the cutting element, in particular, is parallel to the normals of the first cutting plane. Moreover, the normal of the second cutting plane has a further (directional) component which is parallel to a vertical direction when the plow device is positioned on the ground as intended. An angle between the normals can be selected between 45° and 130° degrees, for example, in order to achieve a desired furrow pattern in the ground.

If the first cutting plane and the second cutting plane, in particular, are at ca. 90° to one another, the second cutting element pushes the undercut soil ridge in the direction of the first cutting element. During the movement in the plowing direction, this results in the soil ridge between the first cutting element and the second cutting element advantageously being able to be worked. By the cooperation of the rotating first cutting element with the second fixed cutting element, which is arranged so as to be angled-back, a preferred plowing result or a “crumbling” (clod crushing) is provided. Moreover, the significant lateral pull of the first cutting element, which acts negatively on the tractor pull line, is substantially compensated by the counteraction of the second cutting element. Thus a balance between the transverse forces is achieved. The pulling machine thus remains without significant countersteer in the track, i.e. the plow device is stabilized following the plow, with at the same time a reduced tractive force.

The first cutting element is fastened to the first carrier structure so as to be able to rotate or swivel. Correspondingly, the first cutting element has a first rotational axis about which it rotates. The first cutting element is preferably configured as a cambered cutting plate and has a circular circumferential line. The circumferential first cutting edge is formed along the circumferential line. By means of the first cutting edge, the lateral region of the soil ridge is cut from the furrow wall of the ground and the soil ridge is diverted at the same time to the side. The circumferential first cutting edge has a first cutting region. The first cutting region is that circumferential portion of the first cutting edge which in the plowing direction preferably comes first into contact with the ground and cuts the ground. The first cutting element can have a diameter of approximately 500 mm to approximately 800 mm. Moreover, the first cutting element can have a toothing, be centrally mounted and be adjustable in terms of position relative to the first carrier structure and the second cutting element, preferably by means of a carriage.

It is particularly advantageous if the first cutting element which is rotatable about a rotational axis is cambered or is conical or frustoconical. As a result, it is ensured that the cut-away soil ridge is rotated and deposited in the adjacent furrow generated in a previous passage of a plow module. In this case, the rotational axis of the first cutting element is adjusted at an angle to the plowing direction such that the leading edge of the cutting element forms an angle relative to the plowing direction and the cutting element extends substantially obliquely to the plowing direction and thus to the soil ridge to be cut thereby. The hollow disk is at an incline to the pulling direction and to the perpendicular line of the furrow, i.e. it is inclined relative to the furrow and the pulling direction. The inclination in the pulling direction, also denoted as the cutting angle, is preferably 10 to 30°. The inclination to the perpendicular line of the furrow is preferably 10 to 35°.

The first cutting element is automatically rotated when the plow device is moved along the ground. In this case, frictional forces cause the first cutting element to be moved. The first cutting element is preferably dimensioned such that during plowing only its lower half, which is located below the first rotational axis, penetrates into the ground so that frictional forces with the ground can cause the rotation.

The rotation of the first cutting element, which is configured in a cambered or plate-shaped manner, also causes the cut-away soil ridge to be lifted and at the same time diverted to the side. The cut-away soil ridge, in particular, is in frictional contact with a first cutting surface of the first cutting element. The first cutting surface is that surface of the first cutting element which is configured inside the first cutting edge. Moreover, the first cutting surface is that surface which is oriented toward the cut-away soil ridge. The first cutting surface can be configured uniformly without recesses or elevations. Moreover, the first cutting surface (i.e. the lateral surface of the first cutting element) can form a cone shape or a frustoconical shape.

According to the invention, the second cutting element is configured as a cutting blade and adjustably mounted relative to its angle of attack, wherein the second cutting edge is defined by the fixed edge of the second cutting element. The adjustable cutting blade of the second cutting element has a cutting edge which extends transversely to the plowing direction. The cutting element which is preferably toothed on its edge, is preferably oriented with a defined angle relative to the plowing direction, with its tip slightly to the rear, i.e. it is at an angle of greater than 90° to the plowing direction. By means of the second cutting edge, the base region of the soil ridge is cut from the furrow bed of the ground, undercut and optionally lifted at the same time. The second cutting region is formed by the cutting blade as the second cutting edge which comes second into contact with the ground in the plouging direction and cuts the ground.

The first cutting element, for example a cambered disk, cuts the soil ridge in a first vertical layer plane, for example at a working depth of ca. 15 to 35 cm, starting from the ground surface, and guides the soil ridge into a previously formed furrow.

In the second horizontal layer plane which is at the working depth ca. 15 to 35 cm, starting from the ground surface, the soil ridge is cut by the second cutting element, the cutting blade, horizontally, i.e. from the furrow bed, wherein the dynamic balance of forces between the two cutting elements acts such that a stabilizing effect follows the plow. The spacing of the two cutting planes (above: rotating first vertical cutting element; and below: second horizontal cutting element configured as cutting blade) can be adapted by being able to adjust the rotating cutting element.

The effective plow body, consisting of the main components of the first cambered cutting element and the second planar cutting element in the form of the cutting blade, corresponds approximately to an inclined winding plane which is pulled through the ground. The cut-away soil ridge is displaced along the cambered first cutting element on the inner face thereof upwardly and to the side. This process consists of compressing the upper half of the soil ridge and expanding the lower half of the soil ridge. As a result, compressive, tensile and torsional stresses are produced within the soil ridge, said stresses, in addition to the falling movement of the soil ridge due to gravity, producing the break-up of the ground.

By means of the arrangement according to the invention of the second cutting element, in the plowing direction downstream of the first cutting element, the frictional force which otherwise leads to a high necessary tractive force of the plow device, can be reduced. Since the soil ridge has already been undercut by the second cutting element from the furrow bed when it is cut by the first cutting element on its side, the soil ridge is already lifted and turned by the first cutting element. The second cutting region in the plowing direction, for example, is located between 1 cm and 50 cm, in particular 15 cm to 25 cm downstream of the first cutting region. The substantially horizontal cutting blade, representing the second cutting element, comes second into contact with the ground and runs downstream relative to the substantially vertically arranged first cutting disk or the cutting element, or therebehind. This arrangement of the second cutting element “undercuts” the furrow wall, or the soil ridge to be plowed, horizontally and facilitates thereby the sloping/furrow clearance. The vertically arranged cambered first cutting element cuts away the soil ridge, which has been horizontally precut by means of the downstream second cutting element, vertically with the following pass and by the rotational movement of the hollow disk turns it at the same time and deposits it to the side, preferably into the furrow.

The plow device thus permits a smooth-running plowing effect with plow-following stabilization. The friction coefficient relative to conventional rigid plow bodies is significantly reduced since the first cutting element rotates therewith. By this concept a smooth-running, fuel-saving plow is provided which generates at the same time an approximately uniform furrow pattern which is ready for use as a seedbed, wherein the tractive force is additionally reduced by the dynamic compensation of the transverse forces.

The second cutting element can be adjusted by means of an electrical, mechanical or hydraulic adjusting device relative to its angle of attack, optionally to changing ground conditions, preferably even during plowing.

According to a further exemplary embodiment, the first or even the second cutting edge of the first or second cutting element is configured to be cambered and toothed. A cambered design means that the first or second cutting edge is configured to be bulged. A toothed design means that depressions or elevations (teeth) are formed on the cutting edge. Thus an improved cutting action of the first and the second cutting element can be achieved when cutting off the soil ridge. By means of the spherical cap-shaped design, in particular, of the first cutting element, the soil ridge sliding along said first cutting element can be subjected to turning so that the attachment of a moldboard or guide plate can be dispensed with. The design of the first cutting edge of the first cutting element and/or the second cutting edge of the second cutting element with recesses on the circumference results in a design in the manner of a circular saw blade which penetrates particularly easily through the soil. The hollow disk cutting plate is able to be set in rotation by engagement with the soil.

By means of the described plow device, a saving of tractive force-fuel is possible by the ease of movement thereof. Moreover, the plow device can be universally used and functions in virtually all ground conditions. Moreover, the soil ridge can be continually broken up by the rotational movement of the cutting plate. As a result, the desired crumbling of the clod (clod crushing) can be achieved. The post-cultivation processes can be reduced by the clod crushing effect. This saves working operations until it is used for seedbed cultivation. Moreover, the ground is advantageously thoroughly mixed. Moreover, conventional standard components or standard additional tools, such as fertilizer skimmers and disk coulters, are no longer necessary. Less wear is produced by the rotating first cutting element, whereby spare part costs are reduced. By this gentle ground cultivation, metal abrasion of the cutting elements which is damaging to the humus, is substantially avoided or reduced relative to a plow device with a conventional moldboard.

According to a further exemplary embodiment, the plow device has at least one further plow module, also with a rotatable first cutting element with a further circumferential first cutting edge, and is configured such that when the carrier structure is moved over the ground in the plowing direction, a further lateral region of a further soil ridge is able to be cut away from the ground by means of the further plow module, and the further first cutting element is rotatable so that the further soil ridge can be lifted by means of the further first cutting element.

By the above-described embodiment it is made clear that a plurality of plow modules can be arranged adjacent to one another in the plowing direction, i.e. spaced apart and adjacent to one another in a direction at right-angles to the plowing direction (in a horizontal plane). Thus a plurality of soil ridges, which are arranged adjacent to one another in the plowing direction, can be cut from the ground, lifted and optionally turned.

When arranging a plurality of or a number of corresponding plow modules and thus a corresponding number of cutting elements in the plowing direction one behind the other, due to the lateral offset of the individual plow modules to one another a wider surface can be plowed transversely to the plowing direction in one pass than is the case when only a single plow module is used in a pass. In turn, it is advantageous for the functionality of the plow device if the cutting elements can be pivoted out of engagement and thus out of their adjusted position. Thus it is possible to make a leading cutting element, for example, from a trailing cutting element. Advantageously, when a plurality of plow modules of a plow device are combined, this can be expedient or advantageous for different parameters, such as for example ground conditions, in the sense of an optimal adaptation.

By the ability to adjust the cutting blade in terms of angle as a second cutting element, a dynamic balance of forces of the transverse forces is achieved between the hollow disk and the cutting blade, whereby a plow-following stabilization can be achieved. It goes without saying that the plow device, consisting of the plurality of plow modules, normally requires a higher tractive force the greater the number of plow modules combined together on a carrier to form a plow device. Without the plow-direction stabilization, the laterally acting forces, which promote a lateral drift of the plow device from the straight pull line, might be greater than with the presence of only a single plow module. It is all the more important to provide plow-following stabilization by the corresponding setting or adjustment of the cutting blade, which additionally has a supporting action with plow-direction stabilization by providing a contact plate. It has been shown that the additional contact plate together with an adjustability of the cutting blade in terms of angle, in order to achieve a dynamic balance of forces of the transverse forces from the first cutting element in the form of the hollow disk and the second cutting element in the form of the cutting blade, achieves a plow-following stabilization when, in the case of a plurality of plow modules on a plow device, the first and last plow module in the pulling direction is already provided with such an element, in the form of a contact plate and the cutting blade which is adjustable in terms of angle.

This represents a compromise between a low tractive force and the force causing the plow device to break out to the side from the ideal pull line. Naturally, the higher construction effort for providing the contact plate and the adjustability of the cutting blade for all of the plow modules is justified in an acceptable manner.

By means of the plow device according to the invention, for example, with the upper rotatable cambered first cutting element, the soil ridge of the ground, for example up to 15 centimeters, can be turned in a gentle and flat manner even without a guide plate and without a moldboard. However, an additional contact plate and an adjustability of the angle of attack of the cutting blade provide a plowing-direction stabilization.

In an exemplary embodiment, the first cutting element and the second cutting element are interchangeably arranged (for example by means of screw connections) on the respective carrier structure. The first carrier structure is configured in this case such that it can be releasably mounted on the base frame of the plow device which is preferably carried out via screw connections. Shear bolts, rubber blocks or spring elements can also be provided for protection against stones. The mounting elements provided therefor, such as bores or pins, are preferably designed and arranged such that they are compatible with commercially available base frames for plow devices. Thus the plow module can be easily retrofitted on the basic structure of a plow device in lieu, for example, of a plow body.

The cut-away soil ridge is easily lifted, turned and deposited onto the furrow by the rotation of the first cutting element. When the plow device is moved in the plowing direction, the soil ridge is turned in the plowing direction.

Due to the lifting of the soil ridge by means of the rotating first cutting element, the soil ridge can be deposited in an energy-efficient manner in the plowing direction downstream of the cutting element.

In the plow module according to the invention, the second cutting element is configured as a fixed cutting blade. The cutting blade in this case is configured as a flat, rectangular, straight or curved knife, which is fastened at an end region to the second carrier structure. The fastening is preferably carried out by screwing which also permits a simple replacement of the second cutting element when worn. The edge of the knife faces in its working position in the plowing direction and is generally oriented transversely to this direction.

In an advantageous modification of this design, the cutting blade of the second cutting element is of L-shaped configuration, wherein a first bar of the cutting blade is oriented horizontally in the working position of the plow module, and a second bar is oriented substantially perpendicularly thereto. The first bar thus intersects the base region of the soil ridge to be formed. The second bar, which is vertical in the working position of the plow module, is located upstream of the first cutting element and faciliates the penetration thereof into the ground since it runs substantially in the same plane as the leading edge of the first cutting element. For reasons of mechanical robustness it is expedient if the cutting blade is configured in one piece. Generally it has the shape of a flat knife, which has a sharpened edge on the front face. The angle of attack of the knife relative to the plowing direction is adjustable, in order to ensure that a desired penetration depth of the plow module in the ground is reached and maintained. Together with the contact plate supported in terms of force on the furrow wall, a plow-following stabilization is achieved.

The invention also comprises a plow device as claimed in claim 14, according to the invention at least one plow module being arranged, preferably six to 16 such plow modules being arranged, on the base frame thereof. The plow module in this case is preferably fixedly connected via screw connections to the base frame, wherein the connection is implemented via the first carrier structure. It goes without saying that compatible fastening elements such as bores or threaded bolts have to be configured on the base frame and on the first carrier structure. Alternatively, an adapter element can also be provided in order to adapt and fasten the plow module to different base frames of plow devices. One respective plow module thus can be mounted in a simple manner on a base frame or removed therefrom, for example for maintenance purposes.

For further explanation and better understanding of the present invention, exemplary embodiments are described in more detail hereinafter with reference to the accompanying drawings. In the drawings:

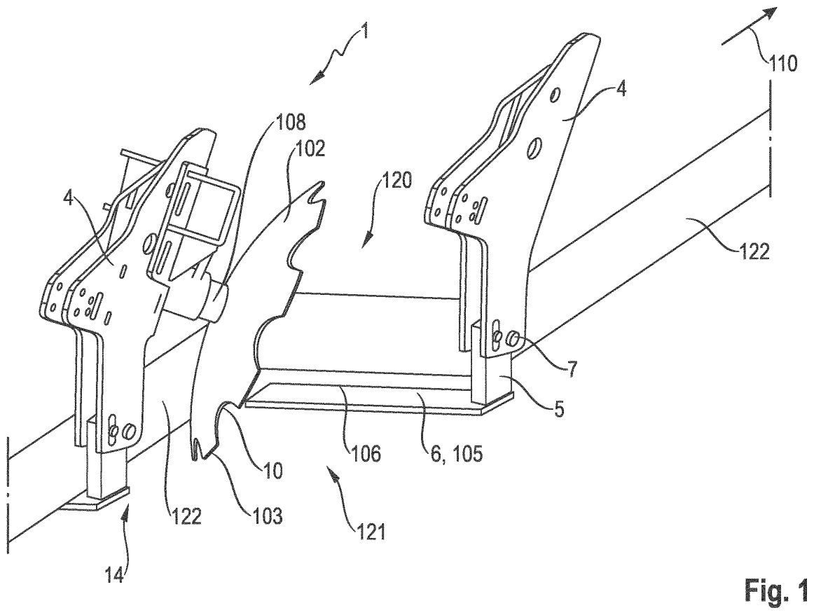

FIG. 1 shows a view of a plow module with a hollow disk and cutting blade;

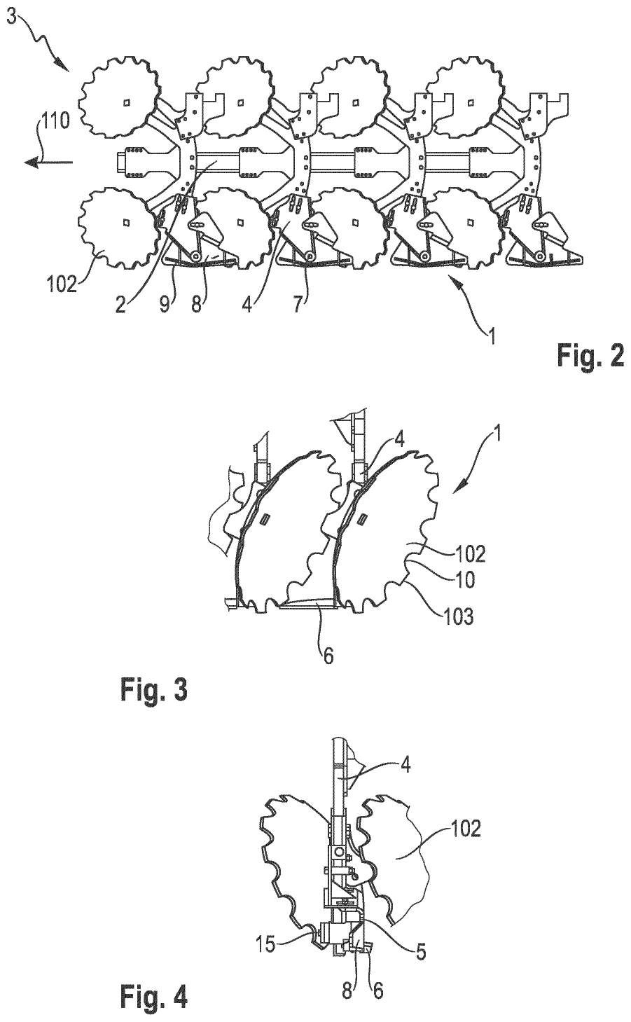

FIG. 2 shows a schematic view of a plow device according to an exemplary embodiment of the present invention;

FIG. 3 shows two plow modules arranged one behind the other in which a hollow disk is shown as the first cutting element and a cutting blade is shown as the second cutting element;

FIG. 4 shows a drawing of a partial view of a plow device according to the invention as a rear view of the drawing according to FIG. 3 with the contact plate; and

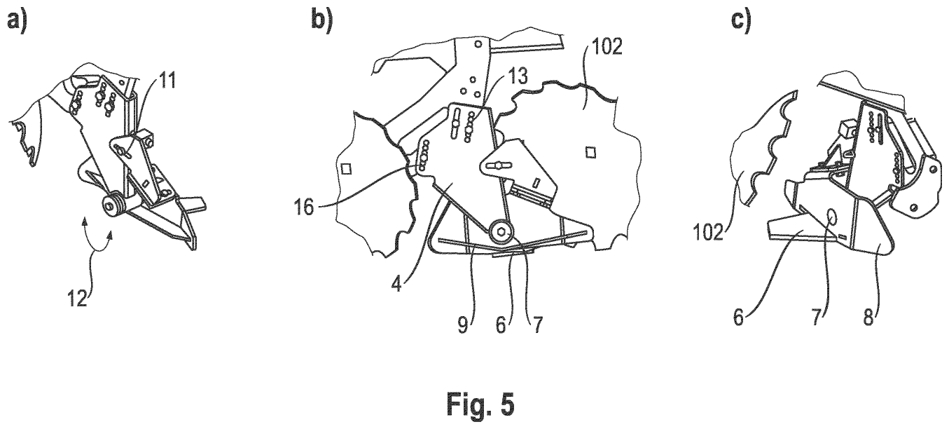

FIGS. 5a), b), c) show three partial views of a plow module according to the invention.

Components which are the same or similar are provided in the various figures with the same reference numerals. The drawings in the figures are substantially schematic and merely by way of example.

FIG. 1 shows a plow module 1 for plowing ground 120 in which a first cutting element 102 in the form of a spherical cap-shaped hollow disk is arranged upstream of a second cutting element 105 in the form of a cutting blade 6, one behind the other in the plowing direction 110. The first cutting element 102 is provided for cutting the side surface of a soil ridge, not shown, whereas the second cutting element 105 arranged downstream of the first cutting element 102 is configured as a cutting blade 6 which cuts the furrow base. Both cutting elements 102, 6/105 are joined together by means of a carrier structure 4, 5 as a plow module. The carrier structure 4, 5 can be fastened to a base frame (not shown), wherein the second cutting element 105 is connected in an articulated manner to the first cutting element 102 via the carrier structure 4 thereof.

As shown in FIG. 1 a rotatable first cutting element 102 with a circumferential cambered first cutting edge 103 is arranged on a first carrier structure 4 and configured such that when the carrier structure 4 moves on the ground 120 in the plowing direction 110 a lateral region 122 of a soil ridge, not shown, of the ground 120 can be cut by means of a first cutting region of the first cutting edge 103, as shown in FIG. 1. The plowing direction 110 is defined as the direction along which the plow device 3 is moved over the ground 120. A second cutting element 105 with a second cutting edge 106 is arranged on a second carrier structure 5 which is releasably connected to the first carrier structure 4 and pivotable relative to the first carrier structure 4 regarding the angle of attack. The second cutting element 105 is configured such that when the carrier structure 5 moves on the ground 120 in the plowing direction 110 a base region of the soil ridge of the ground 120 can be cut away by means of the second cutting region of the second cutting edge 106. The second cutting element 105 is arranged relative to the first cutting element 102 in the plowing direction 110 such that the second cutting region is arranged downstream of the first cutting region in the plowing direction 110. The second cutting region is thus spaced apart from the first cutting region with the spacing x.

Since the base frame 2 of the plow module 1 is pushed with the first and second carrier structure 4 and 5 in the direction of the cut surface 121 or furrow bed of the ground 120 during plowing, the first cutting element 102 is correspondingly also pushed in the direction of the cut surface 121 such that the first cutting element 102 is held at the desired ground depth during plowing.

FIG. 2 shows a schematic view of the essential functional elements of a plow device according to an exemplary embodiment of the present invention. This FIG. 2 shows the correct spatial arrangement of the first and second cutting elements 102 and 105 and the formation and turning of the soil ridge. The remaining components of the associated plow device 3 are not shown for the sake of clarity.

The plow device 3 shown in FIG. 2 has in a conventional design a base frame or a plow tree 2, plow modules 1 accordingly attached on both sides extending therefrom. The plow modules 1 according to the invention have in each case a first cutting element 102 which is configured as a hollow disk, and associated therewith a second cutting element 105 which is configured as a cutting blade 6, with a contact plate 8, which is configured in the manner of a grinding shoe, additionally attached thereto. According to the view of FIG. 2, the plow modules 1 with the contact plate 8 are shown from their rear face, which means that the cutting blade 6, not shown in FIG. 2, extends from the rear face of this contact plate 8. Illustrated is a first carrier structure 4 which provides via a joint 7 the option of the cutting blade 6 together with the contact plate 8, which is located so to speak on the upwardly facing plane of the cutting blade 6, being able to be adjusted to different plowing and ground conditions, in the sense of an adjustability of the angle of attack of the cutting blade 6. One respective module of the plow device 3 thus consists of the first cutting element 102 which is configured as a hollow disk and the cutting blade 6 with the contact plate 8 which is connected via the first carrier structure 4 indirectly to the base frame 2, which is also denoted as a plow tree. The function of the contact plate 8 is to contribute to the dynamic balance of the transverse forces and to be supported on the furrow wall 122, not illustrated, forming the lateral region of a furrow. As a result, a plow-following stabilization can be provided for the plow device 3, in the sense that a stabilizing effect follows the plow due to the fact that the hollow disk 102 generates a lateral force when cutting the ground 120 and subsequently turning the soil ridge produced by the hollow of the disk. Due to this lateral force, which is present without the contact plate 8, the plow device 3 would have the tendency to deviate from its straight following line; a plow-following stabilization would then not take place.

In FIG. 3 two plow modules according to the invention which are arranged one behind the other are shown slightly enlarged relative to FIG. 2, wherein the first cutting element 102 is configured as a cambered hollow disk with a first cutting edge 103 and is configured to be toothed, so to speak, in the recesses provided in the cutting edge. The first carrier structure 4 is indicated on the convex rear face of the hollow disk 102 which at its lower end exhibits the cutting blade 6. The angle of attack of the cutting blade 6 can be adjusted such that a force is exerted in the direction of the ground 121 or the furrow bed (not illustrated), whereby the entire plow module 1 and thus the plow device 3 is held at the desired plowing depth.

As shown in FIG. 1 the carrier structure 4 and 5 for the two cutting elements 102 and 105 is configured to connect together at least the first cutting element 102 and the second cutting element 105 fixedly to the base frame 2 of a plow device 3. The first carrier structure 4 is fastenable via the base frame 2 of the plow device 3 to a traction machine, such as for example a tractor, in order to drive the cutting elements 102, 105 accordingly in the plowing direction 110. The plow module 1 has, for example, the first and second carrier structure 4, 5 which can be configured fixedly or pivotably via joints.

The first and the second carrier structure 4 or 5 form, therefore, a rigid fastening structure for the cutting elements 102, 105. The cutting elements 102, 105 are fixed to the carrier structures 4, 5 such that a relative movement between the positions of the cutting elements 102, 105 is not possible during plowing. If according to the invention, therefore, the second cutting element 105 is pushed in the direction of the ground 120 due to the cutting of the soil ridge, at the same time the first cutting element 102 is also pushed into the ground 120 since both carrier structures 4, 5 are fixedly connected together.

The first cutting element 102 is rotatably fastened and the second cutting element 105, or its angle of attack, is pivotably fastened to the respective carrier structure 4 or 5. Accordingly, the first cutting element 102 has a rotational axis about which the cutting element 102 rotates. The second cutting element 105 forms a pivot axis via the joint 7 about which the second cutting element 105 is pivotable with its angle of attack. The first cutting element 102 is configured by way of example here as a spherical cap-shaped cutting plate and has a circular circumferential line. The corresponding circumferential first cutting edge 103 having recesses 10 is configured along the circumferential line. The lateral region 122 (see FIG. 1) of the soil ridge is cut from the furrow wall 122 of the ground 120 by means of the first cutting edge 103. The circumferential first cutting edge 103 has a cutting region which is that circumferential portion of the first cutting edge 103 which in the plowing direction 110 comes first into contact with the ground 120 and cuts the ground. A base region 121 of the soil ridge is cut from the ground 120 by means of the cutting blade 6 as the second cutting element 105. That circumferential portion of the second cutting element 105 which in the plowing direction 110 is received second in terms of contact with the ground 120, or follows the first cutting element 102 and cuts the ground, is denoted as the second cutting region of the second cutting edge 106. The double arrow 12 in FIG. 5a indicates that the second cutting element 105 is pivotably mounted on the first carrier structure 5, not shown here. The pivoting permits the adjustment of the angle of attack of the cutting blade 6 relative to the plowing direction 110 and thus the penetration depth of the plow module 1 in the ground 120.

A rotatable hexagonal disk (not shown) which precuts or opens the ground 120 with the cutting blade 6 and the first cutting element 102 can be arranged upstream of the plow module 1 or connected thereto. As a result, the tractive force required for plowing is reduced, as is the wear of the cutting blade 6 and the following first cutting element 102. The cutting blade 6 cuts as a double or triple edge horizontally and vertically and cooperates with the contact plate 8 such that a stabilizing effect follows the plow.

The first cutting element 102 is rotated when the plow device 3 moves along the ground 120. In this case, for example, frictional forces cause the cutting element 102 to be moved. The cutting element 102 in this case is dimensioned such that during plowing only the lower half of the first cutting element 102, which is located below the rotational axis thereof, penetrates into the ground 120 so that frictional forces with the ground 120 cause the rotation. The rotation of the first cutting element 102 also causes the cut-away soil ridge to be lifted.

The cut-away soil ridge is in frictional contact with a cutting surface of the cutting element 102. The cutting surface is that surface of the cutting element 102 which is configured inside the first cutting edge 103 or is surrounded thereby. Moreover, the cutting surface is that surface which is oriented toward the cut-away soil ridge. The cutting surface, as illustrated in FIGS. 1 and 3, can be configured uniformly without recesses or elevations.

Due to the lifting of the soil ridge by means of the rotating cutting element 102, the soil ridge can be conveyed into the adjacent furrow in an energy-efficient manner. This furrow has been lifted out by a previous passage of a plow module.

According to FIG. 1, the first cutting element 102 and the second cutting element 105 in this case are fastened relative to one another on the carrier structure 4, 5 such that in the vertical direction the cutting region of the first cutting element 102 is spaced apart from the second cutting element 105 or is located above the second cutting element 105 when the plow device 3 is positioned on the ground 120 in the working position or penetrates into the ground.

The rotating cutting element 102 and the second cutting element 105 cooperate synergistically. On the one hand, by means of the second cutting element 105 a desired plow depth can be kept constant since the cut-away soil ridges push with a defined compressive force/pull-in force onto the second cutting element 105 via the adjusted angle of attack and thus act counter to a lift of the rotating cutting element 102. On the other hand, the action of the rotating cutting element 102 when cutting the soil ridge, which is advantageous in terms of energy, in particular the side surfaces or lateral regions 122 of the soil ridges, is utilized. Thus an energy-efficient plow device 3 is provided without the quality of the furrow pattern being negatively affected. Additionally, the fixed second cutting element 105 causes the cut-away soil ridge to be pushed in the direction of the first cutting element 102 so that the cut-away soil ridge is crumbled. Moreover, due to a lateral force which is input into the first carrier structure 4 by means of the second cutting element 105 mounted upstream, which is achieved in particular by the contact plate 8, a lateral force on the first cutting element 102 caused during the cutting is counteracted, so that a simpler and improved guidance of the plow device 3 with a traction machine, i.e. a plow-following stabilization when plowing, is possible.

The first cutting element 102 and the second cutting element 105 are arranged relative to one another on the first and second carrier structure 4 and 5 such that the front part of the cutting element 105, i.e. the cutting edge thereof, in the plowing direction 110 is located with a spacing x downstream of the first cutting region of the first cutting edge 103 of the first cutting element 102. Thus, during plowing, the fixed second cutting element 105 contacts the soil ridge first at the side and cuts it in an energy-efficient manner with the second cutting edge 106 of the second cutting element 105 from the remaining ground 120. Subsequently, the first cutting element 105 with the first cutting edge 103 cuts the lateral region 122 of a soil ridge. The second cutting element 105 undercuts the furrow wall 122 cut by the first cutting element 102. As a result, the following cutting element 102 of the following plow module 1 can vertically cut the soil ridge at the side and turn it. Then the soil ridge is rotated and deposited in the adjacent furrow due to the bulged shape of the hollow disk as the first cutting element 102 and the oblique orientation thereof to the plowing direction 110. Thus the first cutting element 102 and the second cutting element 105 cut away the soil ridge in an energy efficient manner, and at the same time they are held at the desired cutting depth by the compressive force acting on the second cutting element 105, wherein the contact plate 8 implements a lateral support on the furrow wall 122 such that a stabilizing effect follows the plow device 3.

The second cutting element 105 undercuts the soil ridge with a region (blade surface). A further fastening region of the second cutting element 105, on which a fastening rod for fastening to the first carrier structure 4 is arranged, is formed on the side on the second cutting element 105 remote from the first cutting element 102. Thus, during plowing, the fastening rod runs in an already prepared furrow which reduces the tractive force of the plow device 3.

The carrier structure 4, 5 is configured such that the first cutting element 102 and/or the second cutting element 105 are adjustable relative to one another in the plowing direction 110 and/or perpendicularly, i.e. vertically to the plowing direction 110. For example, the first cutting element 102 can be displaceably fastened to the carrier structure 4 by means of a height adjustment device 16, cooperating by means of slots in the first carrier structure 4. By adjusting the spacings of the cutting element 102, the second cutting element 105 and the carrier structure 4, 5 in the plowing direction 110, the plow device 3 can be adjusted to the specific conditions of different ground types, and used in a manner which is optimized in terms of efficiency. Moreover, the elements can be re-adjusted if the elements are worn after the use of the plow device 3.

Moreover, the carrier structure 4, 5 can be configured such that the first cutting element 102 in a directional component of its rotational axis 108 and the second cutting element 105 in a directional component of its cutting blade extension are adjustable relative to one another. In particular, an angle can be adjusted between the first rotational axis 108 and the cutting blade longitudinal axis. The first cutting element 102 and the second cutting element 105 are in this case fastened relative to one another on the respective carrier structure 4 or 5, such that their cutting planes are not parallel and are at an angle to one another. For example, an angle between the first rotational axis 108 and the cutting blade longitudinal axis is less than 90°, in particular between 45° and 80°.

FIG. 4 shows a rear view of an arrangement according to FIG. 3. The second carrier structure 5 which is provided for receiving the first carrier structure 4 is indicated here. A width setting 15 is provided on the second carrier structure 5 connected to the first carrier structure 4, the spacing of the first cutting element 102 in the form of the hollow disk and the second cutting element 105 in the form of an indicated cutting blade 6 being able to be adjusted thereby. The variable width setting 15 can be undertaken in this case via replaceable spacer washers. The contact plate 8, which is provided for support along the furrow wall 122, not shown in FIG. 4, in the sense of a stabilizing effect following the plow device 3, is shown above the cutting blade 6.

Finally, three partial views of a plow module 1 according to the invention are shown in FIGS. 5a, 5b, 5c.

FIG. 5b shows a rear view of the arrangement of the second cutting element 105 in the from of a cutting blade 6, in which a contact plate 8 is provided for support against the furrow wall 122, wherein the second cutting element 105 extends to the rear from the view shown. In order to make clear the arrangement of both cutting elements 102 or 105 inside a plow module 1, in the view according to FIG. 5b in each case a hollow disk 102 is shown both to the left and to the right from the second cutting element 105 with the contact plate 8. The rear face of the contact plate 8 has a reinforcing plate 9 which provides the contact plate 8 with a greater strength and stability (see FIG. 5c). A joint 7, via which the second cutting element 105 in the form of the cutting blade 6 can be adjusted in a changeable manner relative to the first carrier structure 4 regarding its angle of attack, is illustrated. A height adjustment device 13 is also illustrated, the cutting blade carrier structure unit being adjustable thereby in terms of height relative to the base frame or plow tree 2 of the plow device 3. The height adjustment device 13 relates to the height adjustment of the cutting blade 6. Moreover, a further height adjustment device is provided for the first cutting element 102 in the form of a hollow disk.

FIG. 5a shows a view of the plow module 1 according to the invention from the right-hand side of the rear view shown in FIG. 5b, whereas FIG. 5c shows a lateral view of the rear view according to FIG. 5b from the left.

The pivotability of the second cutting element 105 in the form of the cutting blade 6 about the joint 7 is identified in FIG. 5a by the double arrow 12. A corresponding blocking of the adjusted angle of attack of the cutting blade 6 is carried out by an inclination fixing device 11.

The side view 5c to the left of the rear view according to FIG. 5b shows that in the sense of plow-following stabilization the contact plate 8 bears against the furrow wall, not shown in FIG. 5c, in the sense of a longitudinal guide, whereas the furrow bed 121 for the soil ridge still to be cut away, which is cut away and turned by the indicated hollow disk 102, is already cut by the cutting blade 6 at a depth in the soil to be plowed. The fact that the cutting blade 6 penetrates the contact plate 8 and in its position is fixedly fastened therein and also can be pivoted via the joint 7 together with the cutting blade 6, means that even with a changed angle of attack the contact plate 8 is always pivoted together with the cutting blade 6.

### LIST OF REFERENCE NUMERALS

1 Plow module
2 Base frame/plow tree
3 Plow device
4 First carrier structure
5 Second carrier structure
6 Cutting blade
7 Joint
8 Contact plate
9 Reinforcing plate
10 Recess
11 Inclination fixing device
12 Double arrow
13 Height adjustment, cutting blade
14 Furrow
15 Width setting
16 Height adjustment, hollow disk
102 First cutting element, hollow disk
103 First cutting edge
105 Second cutting element
106 Second cutting edge
108 Rotational axis of first cutting element
110 Plowing direction
120 Ground
121 Cutting surface/furrow bed/base region
122 Lateral region/furrow wall

1. A plow module having plow-following stabilization for interchangeable mounting on a base frame of a plow device for plowing ground, wherein the plow module comprises:
a rotatable first cutting element which is configured as a hollow disk cutting plate, with a circumferential first cutting edge, wherein the first cutting element is configured such that a lateral region of a soil ridge of the ground can be cut away by moving the plow module on the ground in a plowing direction,
a second planar cutting element with a second cutting edge,
wherein the second cutting element is configured such that a base region of a soil ridge of the ground can be cut away by moving the plow module on the ground in a plowing direction,
the plow module being configured as a fully mounted structural unit, in which the second cutting element which is configured as a fixed cutting blade follows the first cutting element in the plowing direction with its cutting edge and
a first carrier structure on which the first cutting element is arranged,
a second carrier structure on which the second cutting element is arranged and which is connected to the first carrier structure, is provided and
the first carrier structure has means for the releasable fastening to a base frame of a plow device, wherein
the cutting blade is angled back to the rear such that a dynamic balance of forces can be achieved between the first cutting element and the cutting blade in the sense of a plow-following stabilization, and
the cutting blade cooperates with an additionally provided contact plate which is supported on a furrow wall such that a stabilizing effect follows the plow, the lateral region of the soil ridge being cut away from said furrow wall.

2. The plow module as claimed in claim 1, wherein the second carrier structure is pivotably connected via a joint to the first carrier structure.

3. The plow module as claimed in claim 1, wherein the first cutting element is displaceably arranged on the first carrier structure such that the spacing between the first cutting edge of the first cutting element and the second cutting edge of the second cutting element is adjustable.

4. The plow module as claimed in claim 1, wherein the first cutting element and second cutting element are arranged relative to one another such that a cutting region of the first cutting edge of the first cutting element is vertically spaced apart from the second cutting edge of the second cutting element.

5. The plow module as claimed in claim 4, wherein the first cutting region is configured in a first cutting plane and a second cutting region is configured in a second cutting plane, wherein the first cutting plane and the second cutting plane form relative to one another an angle of 30° to 135°.

6. The plow module as claimed in claim 1, wherein the first cutting element is configured to be cambered, conical or frustoconical.

7. The plow module as claimed in claim 1, wherein the first cutting edge of the first cutting element has recesses on the circumference.

8. The plow module as claimed in claim 1, wherein the cutting blade of the second cutting element is of L-shaped configuration, wherein a first bar of the cutting blade is oriented horizontally in the working position of the plow module and a second bar is oriented substantially perpendicularly thereto.

9. The plow module as claimed in claim 1, wherein the cutting blade is configured in one piece.

10. The plow module as claimed in claim 1, wherein the cutting blade forms with the contact plate an adjustable furrow base-cutting edge-guide unit.

11. The plow module as claimed in claim 10, wherein the furrow base-cutting edge-guide unit is adjustable in terms of depth by means of a height adjustment device configured as a perforated plate-suspension device.

12. The plow module as claimed in claim 1, wherein for adjusting the pull-in force the cutting blade has an angle of attack which can be adjusted via its rotational axis.

13. The plow module as claimed in claim 1, wherein the cutting blade has a spacing from the furrow wall which can be adjusted by means of spacer washers.

14. A plow device comprising a base frame, wherein at least one plow module with plow-following stabilization is arranged on the base frame thereof, the at least one plow module as claimed in claim 1.

15. The plow module as claims in claim 5, wherein the first cutting plane and the second cutting plane form relative to one another an angle of 45° to 110°.
